(19) United States
(12) Patent Application Publication
(10) Pub. No.: US 2021/0131393 A1
(43) Pub. Date: May 6, 2021

(54) FUEL INJECTION VALVE

(71) Applicant: DENSO CORPORATION, Kariya-city (JP)

(72) Inventors: Hiroki TANADA, Kariya-city (JP); Motoya KAMBARA, Nisshin-city (JP)

(21) Appl. No.: 17/149,358

(22) Filed: Jan. 14, 2021

Related U.S. Application Data
(63) Continuation of application No. PCT/JP2019/025081, filed on Jun. 25, 2019.

(30) Foreign Application Priority Data
Jul. 18, 2018 (JP) 2018-134991

(51) Int. Cl. F02M 47/02; F02M 61/10

(52) U.S. Cl. CPC F02M 47/027; F02M 2547/006; F02M 61/10

(57) ABSTRACT

The fuel injection valve includes a valve body having an injection hole at an end of the valve body facing in a first direction, and a needle valve provided inside the valve body and movable in an axial direction which includes the first direction and a second direction opposite to the first direction. A first control valve and a second control valve control the internal pressure of a back pressure chamber provided inside the valve body, a first actuator controls the first control valve, and a second actuator controls the second control valve. The second control valve is longer than the first control valve in the axial direction. The second actuator is located away in the second direction from the first actuator. A part of the second actuator overlaps at least a part of the first actuator when viewed in a plan view along the axial direction.

### CROSS REFERENCE TO RELATED APPLICATIONS

The present application is a continuation application of International Patent Application No. PCT/JP2019/025081 filed on Jun. 25, 2019, which designated the U.S. and claims the benefit of priority from Japanese Patent Application No. 2018-134991 filed on Jul. 18, 2018. The entire disclosures of all of the above applications are incorporated herein by reference.

### TECHNICAL FIELD

The present disclosure relates to a fuel injection valve that injects fuel.

### BACKGROUND

A fuel injection valve includes a valve body, a needle valve, first and second control valves, and first and second actuators. The valve body has an injection hole formed at a lower end of the valve body. The needle valve is provided to be displaceable in an up-down direction inside the valve body, and moves downward to close the injection hole and moves upward to open the injection hole.

### SUMMARY

A fuel injection valve according to at least one embodiment includes a valve body having an injection hole at an end of the valve body facing in a first direction, and a needle valve provided inside the valve body and movable in an axial direction which includes both the first direction and a second direction opposite to the first direction. The needle valve closes the injection hole according to a movement of the needle valve in the first direction, and the needle valve opens the injection hole according to a movement of the needle valve in the second direction. A back pressure chamber is provided inside the valve body such that the needle valve faces the back pressure chamber in the second direction. An increase in internal pressure of the back pressure chamber causes the movement of the needle valve in the first direction, and a decrease in internal pressure of the back pressure chamber causes the movement of the needle valve in the second direction. The fuel injection valve includes a first control valve provided inside the valve body and configured to control the internal pressure of the back pressure chamber, a second control valve provided inside the valve body and configured to control the internal pressure of the back pressure chamber, a first actuator configured to control the first control valve, and a second actuator configured to control the second control valve. The second control valve is longer than the first control valve in the axial direction. A direction orthogonal to the axial direction is defined as a lateral direction, and a part of the second control valve is arranged side by side in the lateral direction with at least a part of the first control valve. An end of the second control valve facing in the second direction is located away in the second direction from an end of the first control valve facing in the second direction. The second actuator is located away in the second direction from the first actuator. A part of the second actuator overlaps at least a part of the first actuator when viewed in a plan view along the axial direction.

### BRIEF DESCRIPTION OF DRAWINGS

The above and other objects, features and advantages of the present disclosure will become more apparent from the following detailed description made with reference to the accompanying drawings. In the drawings:

FIG. 1 is a front sectional view showing a fuel injection valve according to a first embodiment;

FIG. 2 is an enlarged front sectional view of a part of the fuel injection valve of FIG. 1;

FIG. 3 is a plan sectional view of the fuel injection valve of FIG. 2;

FIG. 4 is a sectional view of the fuel injection valve of FIG. 3 taken at an angle different from that of FIG. 2;

FIG. 5 is a view showing an arrangement of a control valve and an actuator of a first comparative example;

FIG. 6 is a view showing an arrangement of a control valve and an actuator of a second comparative example; and

FIG. 7 is a view showing an arrangement of a control valve and an actuator of the first embodiment.

### DETAILED DESCRIPTION

A comparative example will be described below. A fuel injection valve of the comparative example includes a valve body, a needle valve, first and second control valves, and first and second actuators. The valve body has an injection hole formed at a lower end of the valve body. The needle valve is provided to be displaceable in an up-down direction inside the valve body, and moves downward to close the injection hole and moves upward to open the injection hole. A back pressure chamber is provided upward of the needle valve inside the valve body. The needle valve moves downward by an internal pressure increase of the back pressure chamber, and moves upward by an internal pressure decrease of the back pressure chamber. Both the control valves are provided inside the valve body and movable in an up-down direction so as to control the pressure in the back pressure chamber. The first actuator drives the first control valve. The second actuator drives the second control valve.

In such a fuel injection valve of the comparative example, the first control valve is arranged inside the second control valve so as to be coaxial with the second control valve.

In the comparative example, since the first actuator is arranged inside the second actuator, outward expansion of a magnetic pole surface area of the first actuator may be limited, and inward expansion of a magnetic pole surface area of the second actuator may be limited. As a result, the driving force of the actuator may be also limited. Therefore, application to a high pressure fuel system becomes difficult.

In contrast, the present disclosure can facilitate application of a fuel injection valve to a high-pressure fuel system by providing a room to increase an area and a driving force of a first actuator or a second actuator while achieving space-saving of the first and second actuators.

A fuel injection valve of an aspect of the present disclosure includes a valve body having an injection hole at an end of the valve body facing in a first direction, and a needle valve provided inside the valve body and movable in an axial direction which includes both the first direction and a second direction opposite to the first direction. The needle valve closes the injection hole according to a movement of the needle valve in the first direction, and the needle valve opens the injection hole according to a movement of the needle valve in the second direction. A back pressure chamber is provided inside the valve body such that the needle valve faces the back pressure chamber in the second direction. An increase in internal pressure of the back pressure chamber causes the movement of the needle valve in the first direction, and a decrease in internal pressure of the back pressure chamber causes the movement of the needle valve in the second direction. The fuel injection valve includes a first control valve provided inside the valve body and configured to control the internal pressure of the back pressure chamber, a second control valve provided inside the valve body and configured to control the internal pressure of the back pressure chamber, a first actuator configured to control the first control valve, and a second actuator configured to control the second control valve.

The second control valve is longer than the first control valve in the axial direction. A direction orthogonal to the axial direction is defined as a lateral direction, and a part of the second control valve is arranged side by side in the lateral direction with at least a part of the first control valve. An end of the second control valve facing in the second direction is located away in the second direction from an end of the first control valve facing in the second direction. The second actuator is located away in the second direction from the first actuator. A part of the second actuator overlaps at least a part of the first actuator when viewed in a plan view along the axial direction.

According to the present disclosure, since the second control valve is longer than the first control valve, the second actuator that drives the second control valve is arranged in an area away in the second direction from the first actuator that drives the first control valve while the second control valve is arranged side by side in the lateral direction with the first control valve. Accordingly, the first actuator and the second actuator are prevented from interfering with each other, and a part of the second actuator is overlapped with the first actuator in the plan view. Therefore, while saving the spaces of the first and second actuators, it is easy to increase a magnetic pole surface area of the first actuator or the second actuator and increase a driving force. Therefore, it becomes easy to be used for a high pressure fuel system.

Embodiments of the present disclosure will be described with reference to drawings. It is noted that, the present disclosure is not limited to the embodiments and may be implemented with appropriate modification without departing from the gist of the disclosure.

### First Embodiment

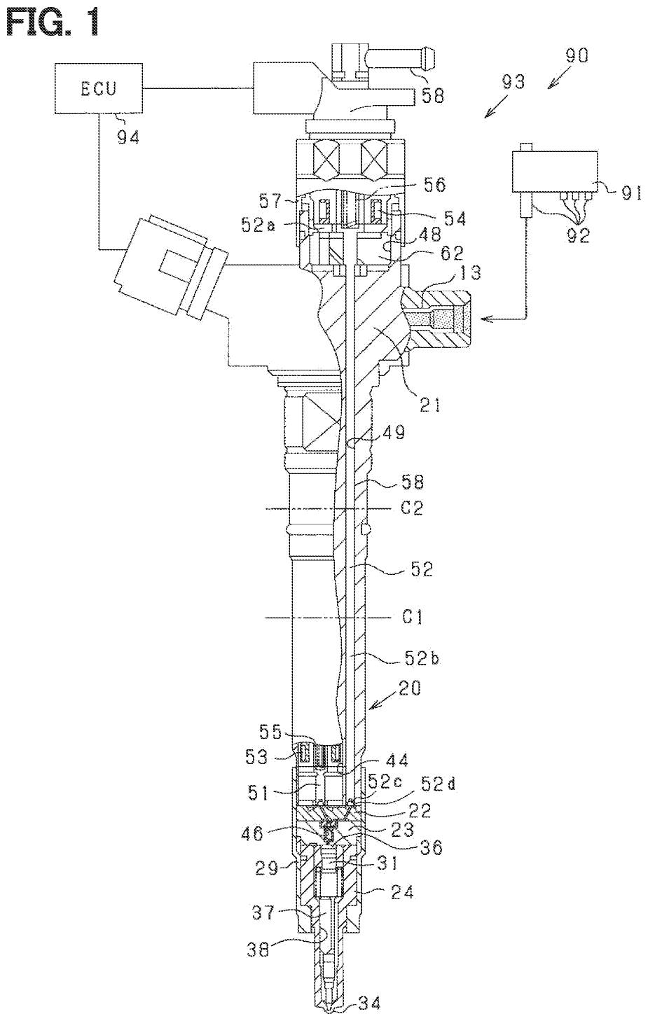

FIG. 1 is a front sectional view showing a fuel injection valve 93 according to a first embodiment. The fuel injection valve 93 is provided in a fuel injection system 90 which is applied to an engine of an automobile. A liquid fuel, such as diesel fuel, gasoline, an ethanol or a mixture of them can be used as a fuel for the engine.

The fuel injection system 90 includes a pressure accumulator 91, a high pressure pipe 92, the fuel injection valve 93, and an ECU 94. The pressure accumulator 91 is supplied with high-pressure fuel from a high-pressure pump (not shown). The pressure accumulator 91 retains therein a high-pressure fuel in a high-pressure state. Each fuel injection valve 93 (only one is shown in FIG. 1) is connected to the pressure accumulator 91 via a corresponding high pressure pipe 92.

The fuel injection valve 93 includes a valve body 20, a needle valve 31, a first control valve 51, a second control valve 52, a first actuator 53 and a second actuator 54. In the following description, one of longitudinal directions (axial direction) of the needle valve 31 is referred to as a down direction and the other of the longitudinal directions is referred to as an up direction in accordance with the drawings. However, the fuel injection valve 93 may be arranged in any direction. For example, the longitudinal directions may be oblique to the up-down direction, or the longitudinal directions may be parallel to the horizontal direction. The down direction in the present embodiment corresponds to a first direction in the present disclosure, and the up direction in the present embodiment corresponds to a second direction in the present disclosure. Moreover, hereinafter, a direction orthogonal to the longitudinal directions (up-down direction) of the needle valve 31 is referred to as a lateral direction.

The valve body 20 includes a nozzle body 24, a control chamber plate 23, an orifice plate 22, and an injector body 21 in order from the bottom. The nozzle body 24, the control chamber plate 23 and the orifice plate 22 are fastened to a lower part of the injector body 21 by a retaining nut 29.

The nozzle body 24 is a tubular member that opens upward, and has an injection hole 34 at a lower end thereof. The needle valve 31 is inserted into the nozzle body 24 so as to be displaceable in the up-down direction. A part of an inner peripheral surface of the nozzle body 24 forms a guide 38 that slidably contacts an outer peripheral surface of the needle valve 31 and thereby guides the needle valve 31 in the up-down direction. The needle valve 31 moves downward to close the injection hole 34 and moves upward to open the injection hole 34. The valve body 20 has therein a high pressure passage 13, a control chamber 46, a back pressure chamber 36, and a low pressure passage 58.

The pressure accumulator 91 supplies a high pressure fuel to the injector body 21 through the high pressure pipe 92, and then the high pressure fuel is sent to the injection hole 34 through the high pressure passage 13. The high pressure passage 13 extends to the nozzle body 24 through the injector body 21, the orifice plate 22, and the control chamber plate 23. Further, a gap between the inner peripheral surface of the nozzle body 24 and the needle valve 31 also forms a part of the high pressure passage 13. A cut portion 37 for securing the high pressure passage 13 is provided between a part of the needle valve 31 and a part of the guide 38 that are in slidably contact with each other.

The low pressure passage 58 is a passage for releasing the pressures in the back pressure chamber 36 and the control chamber 46, and is provided in the injector body 21.

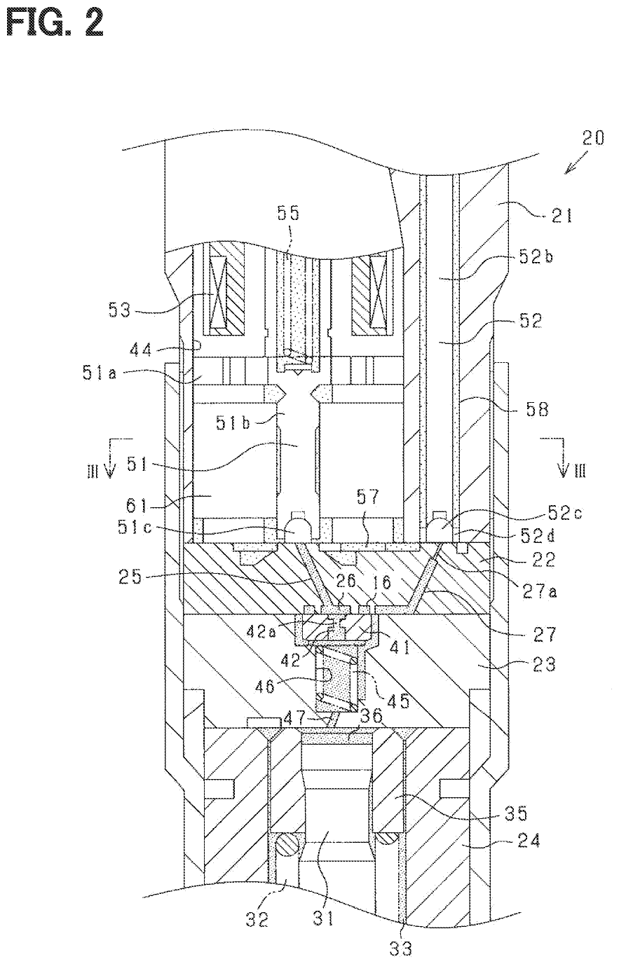

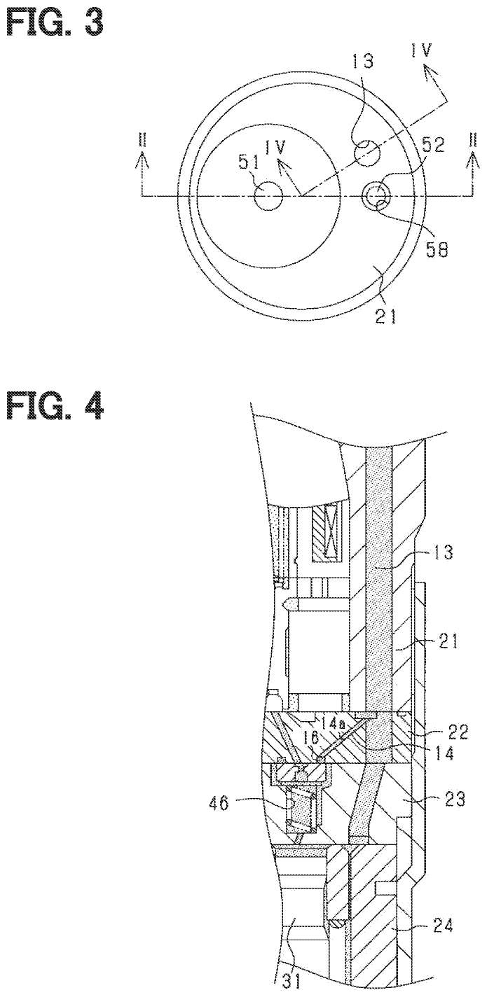

FIG. 2 is a diagram in which a part of FIG. 1 is enlarged. More specifically, a sectional view taken along the line III-Ill of FIG. 2 is FIG. 3, and a sectional view taken along the line II-II of FIG. 3 is FIG. 2.

The back pressure chamber 36 is provided upward of the needle valve 31 inside the nozzle body 24. Specifically, a cylinder 35 is fitted on an upper part of the needle valve 31, and a needle valve spring 32 is provided between the cylinder 35 and the needle valve 31. The needle valve spring 32 presses downward the needle valve 31, and accordingly a reaction force is generated to press upward the cylinder 35. This pressing force causes the cylinder 35 to be pressed against the control chamber plate 23. A space surrounded by the control chamber plate 23, the cylinder 35, and the needle valve 31 forms the back pressure chamber 36. The needle valve 31 moves downward by an internal pressure increase of the back pressure chamber 36, and the needle valve 31 moves upward by an internal pressure decrease of the back pressure chamber 36.

A recess is provided on the control chamber plate 23 and opens upward, and the opening of the recess is closed by the orifice plate 22. Accordingly, the control chamber 46 is formed. The control chamber 46 communicates with the back pressure chamber 36 via a connection path 47 provided in the control chamber plate 23. A recess is provided at the lower end part of the orifice plate 22, and the recess opens downward and forms an intermediate chamber 26. A first outflow passage 25 is provided so as to penetrate from a ceiling surface of the recess (i.e. intermediate chamber 26) to an upper end surface of the orifice plate 22. The intermediate chamber 26 and the low pressure passage 58 communicate with each other through the first outflow passage 25. The recess forming the intermediate chamber 26 functions as a pressure chamber by closing its opening. Further, an annular groove 16 is provided around the intermediate chamber 26 on the lower end surface of the orifice plate 22. The annular groove 16 has an annular shape and faces downward. Moreover, the orifice plate 22 is provided with the second outflow passage 27 that extends therethrough in the up-down direction. The second outflow passage 27 connects the control chamber 46 to the low pressure passage 58, and the second outflow passage 27 is provided with the outflow passage orifice 27a.

The control chamber 46 houses a driven valve 41 to be displaceable in the up-down direction, and a driven valve spring 45 that presses the driven valve 41 upward. When the driven valve 41 contacts a ceiling surface of the control chamber 46, the driven valve 41 closes the opening of the intermediate chamber 26 and the opening of the annular groove 16. The driven valve 41 has a communication passage 42 through which the control chamber 46 communicates with the intermediate chamber 26. The communication passage 42 is provided with a communication passage orifice 42a. On the other hand, the first outflow passage 25 is not provided with an orifice. Therefore, when the driven valve 41 is in contact with a ceiling surface of the control chamber 46 and the upper opening of the first outflow passage 25 is open, a high-pressure fuel flowing into the intermediate chamber 26 through the communication passage orifice 42a is quickly discharged into the low pressure passage 58 from the first outflow passage 25 having no orifice. On the other hand, when the driven valve 41 is in contact with the ceiling surface of the control chamber 46 and the upper opening of the first outflow passage 25 is closed, a high-pressure fuel flowing into the intermediate chamber 26 through the communication passage orifice 42a is accumulated in the intermediate chamber 26, and thereby the pressure in the intermediate chamber 26 increases.

FIG. 4 is a cross-sectional view taken along a line IV-IV of FIG. 3. An injector body 21, the orifice plate 22 and the control chamber plate 23 are each provided with a hole that forms a part of a high pressure passage 13. These holes are provided behind the low pressure passage 58 in a front view.

The orifice plate 22 has an inflow passage 14 for allowing the high pressure fuel in the high pressure passage 13 to flow into the control chamber 46. The inflow passage 14 communicates with the annular groove 16. The inflow passage 14 is provided with an inflow passage orifice 14a.

As shown in FIG. 2, a lower end part of the injector body 21 has a first housing recess 44 that has a cylindrical shape and opens downward. The first housing recess 44 houses a first control valve 51 and a first actuator 53.

The first control valve 51 is a valve for opening and closing the upper opening of the first outflow passage 25. The first control valve 51 moves upward to open the upper opening of the first outflow passage 25 and moves downward to close the opening. The first control valve 51 includes a rod portion 51b having a rod shape extending in the up-down direction, an umbrella portion 51a having an umbrella shape provided at an upper end of the rod portion 51b, and a valve portion 51c attached to a lower end of the rod portion 51b. The first control valve 51 is shorter than the needle valve 31 in the up-down direction. A first support member 61 is disposed inside the first housing recess 44 and supports the rod portion 51b to be slidable in the up-down direction. Specifically, the first support member 61 is a tubular member, and the rod portion 51b is inserted inside the support member 62 and slidable in the up-down direction. A gap between the respective members inside the first housing recess 44 constitutes a part of the low pressure passage 58.

An upper part of the valve portion 51c has a hemispherical shape, and the hemispherical upper part is housed in a hemispherical concave part provided in a lower end surface of the rod portion 51b. Thereby, the valve portion 51c is rotatably engaged with the lower end part of the rod portion 51b. Therefore, for example, even when the rod portion 51b is slightly inclined from a desired position due to an error in dimensional accuracy, thermal expansion, disturbance, etc., this inclination can be absorbed between the rod portion 51b and the valve portion 51c. Therefore, the valve portion 51c can reliably close the upper opening of the first outflow passage 25. The rod portion 51b and the valve portion 51c are displaced together in the up-down direction. A stroke length of the first control valve 51 in the up-down direction is shorter than a stroke length of the needle valve 31 in the up-down direction.

The first actuator 53 drives the first control valve 51 in the up-down direction by acting on an upper end portion (i.e. the umbrella portion 51a) of the first control valve 51. More specifically, a first control valve spring 55 is provided above the first control valve 51 and presses the first control valve 51 downward. The first actuator 53 having a tubular shape is provided around the first control valve spring 55. In the present embodiment, the first actuator 53 is a solenoid and, when energized, attracts the upper end part of the first control valve 51 by magnetic force, thereby lifting up the first control valve 51. As a result, the upper opening of the first outflow passage 25 is opened. On the other hand, when the energization is terminated, the attraction is stopped and the first control valve 51 moves down by pressing force of the first control valve spring 55. As a result, the upper opening of the first outflow passage 25 is closed. The energization of the first actuator 53 is controlled by the ECU 94.

As shown in FIG. 1, an upper end part of the injector body 21 has a second housing recess 48 that has a cylindrical shape and opens upward. In a plan view, the center line of the second housing recess 48 and the center line of the first housing recess 44 are eccentric. The injector body 21 is provided with a valve attachment hole 49 that penetrates from a bottom surface of the second housing recess 48 to the lower end surface of the injector body 21.

The second control valve 52 is a valve for opening and closing the upper opening of the second outflow passage 27. The second control valve 52 moves upward to open the upper opening of the second outflow passage 27 and moves downward to close the opening. The second control valve 52 includes a rod portion 52b having a rod shape extending in the up-down direction, an umbrella portion 52a having an umbrella shape provided at an upper end of the rod portion 52b, a valve portion 52c attached to a lower end of the rod portion 52b, and a ring 52d fitted to an outer peripheral of the valve portion 52c. In the present embodiment, in the second control valve 52, the umbrella portion 52a and a rod portion 52b are integrally formed, and the valve portion 52c and the ring 52d are formed separately from them. The umbrella portion 52a and the rod portion 52b may be formed as separate bodies, and then they may be joined together. Further, the rod portion 52b may be divided into multiple members in the up-down direction and then joined together.

The rod portion 52b, the valve portion 52c and the ring 52d are inserted into the valve attachment hole 49, and the umbrella portion 52a is housed in the second housing recess 48. Therefore, the second control valve 52 is slidable in the up-down direction in the injector body 21. The second control valve 52 is longer than the needle valve 31 in the up-down direction. A stroke length of the second control valve 52 in the up-down direction is shorter than a stroke length of the needle valve 31 in the up-down direction. A second support member 62 is disposed inside the second housing recess 48 and supports the upper part of the rod portion 52b to be slidable in the up-down direction. Specifically, the second support member 62 is a tubular member, and the upper part of the rod portion 52b is slidably inserted inside the support member 62. A part of the second housing recess 48 below the second support member 62 forms a part of the low pressure passage 58. The valve portion 52c has the same shape and function as the valve portion 51c of the first control valve 51.

As shown in FIG. 2, a gap between the inner peripheral surface of the valve attachment hole 49 and the rod portion 52b constitutes a part of the low pressure passage 58. Specifically, an inner diameter of the valve attachment hole 49 is slightly larger than an outer diameter of the second control valve 52. The ring 52d prevents the lower end portion of the second control valve 52 from sliding on the inner peripheral surface of the valve attachment hole 49 in the lateral direction.

As shown in FIG. 1, the lower end of the second control valve 52 is located below a center C1 of the valve body 20 in the up-down direction, and the upper end of the second control valve 52 is located above the center C1 of the valve body 20 in the up-down direction. The center C1 of the valve body 20 in the up-down direction is a bisector of a line segment that extends in the up-down direction from the height of the lower end of the nozzle body 24 to the height of the upper end of the injector body 21. More specifically, the lower end of the second control valve 52 is located below a center C2 of the injector body 21 in the up-down direction, and the upper end of the second control valve 52 is located above the center C2 of the injector body 21 in the up-down direction. The center C2 of the injector body 21 in the up-down direction is a bisector of a line segment that extends in the up-down direction from the height of the lower end of the injector body 21 to the height of the upper end of the injector body 21. Further specifically, in the present embodiment, the lower end of the second control valve 52 is located at the lower end part of the injector body 21, and the upper end of the second control valve 52 is located at the upper end part of the injector body 21.

The second actuator 54 drives the second control valve 52 in the up-down direction by acting on an upper end portion (i.e. the umbrella portion 52a) of the second control valve 52. More specifically, a second control valve spring 56 is provided above the second control valve 52 and urges the second control valve 52 downward. The second actuator 54 having a tubular shape is provided around the second control valve spring 56. In the present embodiment, the second actuator 54 is a solenoid and, when energized, attracts the upper end part of the second control valve 52 by magnetic force, thereby lifting up the second control valve 52. As a result, the upper opening of the second outflow passage 27 is opened. On the other hand, when the energization is terminated, the attraction is stopped and the second control valve 52 moves down by pressing force of the second control valve spring 56. As a result, the upper opening of the second outflow passage 27 is closed. The second actuator 54 is attached to the upper part of the injector body 21 by a fastening member 57. The energization of the second actuator 54 is controlled by the ECU 94.

Next, with reference to FIG. 2, the functions of the fuel injection valve 93 of the present embodiment will be described. Basically, when the first control valve 51 is opened, regardless of whether the second control valve 52 is opened or closed, the pressures inside the control chamber 46 and the back pressure chamber 36 become low, and the needle valve 31 moves upward. However, when the first control valve 51 is opened while the second control valve 52 is open, the pressures inside the control chamber 46 and the back pressure chamber 36 become low relatively quickly. When the first control valve 51 is opened while the second control valve 52 is closed, the pressures in the control chamber 46 and the back pressure chamber 36 become low relatively slowly. Further, basically, when the first control valve 51 is closed, regardless of whether the second control valve 52 is opened or closed, the pressures inside the control chamber 46 and the back pressure chamber 36 become high, and the needle valve 31 moves downward. However, when the first control valve 51 is closed while the second control valve 52 is closed, the pressures inside the control chamber 46 and the back pressure chamber 36 become high relatively quickly. When the first control valve 51 is closed and at the same time the second control valve 52 is opened, the pressures in the control chamber 46 and the back pressure chamber 36 become high relatively slowly. The details are described as follows.

When at least the first control valve 51 is closed, the pressures in the control chamber 46 and the back pressure chamber 36 are high and the needle valve 31 is at the lowest. In this state, when both the first control valve 51 and the second control valve 52 become open, the pressure in the control chamber 46 releases to the low pressure passage 58 through the communication passage 42, the intermediate chamber 26 and the first outflow passage 25, and also releases to the low pressure passage 58 from the second outflow passage 27. Therefore, the pressures inside the control chamber 46 and the back pressure chamber 36 relatively quickly become low, and the needle valve 31 moves upward relatively quickly.

On the other hand, in the state where the needle valve 31 is at the lowest, when the first control valve 51 is opened and while the second control valve 52 is closed, the pressure in the control chamber 46 releases to the low pressure passage 58 through the communication passage 42, the intermediate chamber 26 and the first outflow passage 25, but does not release to the low pressure passage 58 from the second outflow passage 27. Therefore, the pressures inside the control chamber 46 and the back pressure chamber 36 relatively slowly become low, and the needle valve 31 moves upward relatively slowly.

When at least the first control valve 51 is open, the pressures in the control chamber 46 and the back pressure chamber 36 are low and the needle valve 31 is at the highest. In this state, when both the first control valve 51 and the second control valve 52 become closed, the pressure between the control chamber 46 and the intermediate chamber 26 through the communication passage orifice 42a does not release to the low pressure passage 58 from the first outflow passage 25. As a result, the pressure in the intermediate chamber 26 increases. Due to the pressure increase in the intermediate chamber 26, the driven valve 41 is pushed downward, and the driven valve 41 is separated from the ceiling surface of the control chamber 46. Therefore, the annular groove 16 is opened, and the high-pressure fuel in the high pressure passage 13 flows into the control chamber 46 through the inflow passage 14 and the annular groove 16. At this time, since both control valves 51 and 52 are closed, the inflow high pressure fuel accumulates in the control chamber 46 and the back pressure chamber 36 as it is. Accordingly, the pressures inside the control chamber 46 and the back pressure chamber 36 relatively quickly become high, and the needle valve 31 moves downward relatively quickly.

On the other hand, in the state where the needle valve 31 is at the highest, also when the first control valve 51 becomes closed while the second control valve 52 is open, the driven valve 41 is separated from the ceiling surface of the control chamber 46 by the same mechanism as above. Thus, the high pressure fuel in the high pressure passage 13 flows into the control chamber 46. Therefore, the pressure in the control chamber 46 increases. However, at this time, since the second control valve 52 is open, a part of the inflow high pressure fuel flows out to the low pressure passage 58 through the second outflow passage 27. Therefore, the pressures inside the control chamber 46 and the back pressure chamber 36 relatively slowly become high, and the needle valve 31 moves downward relatively slowly.

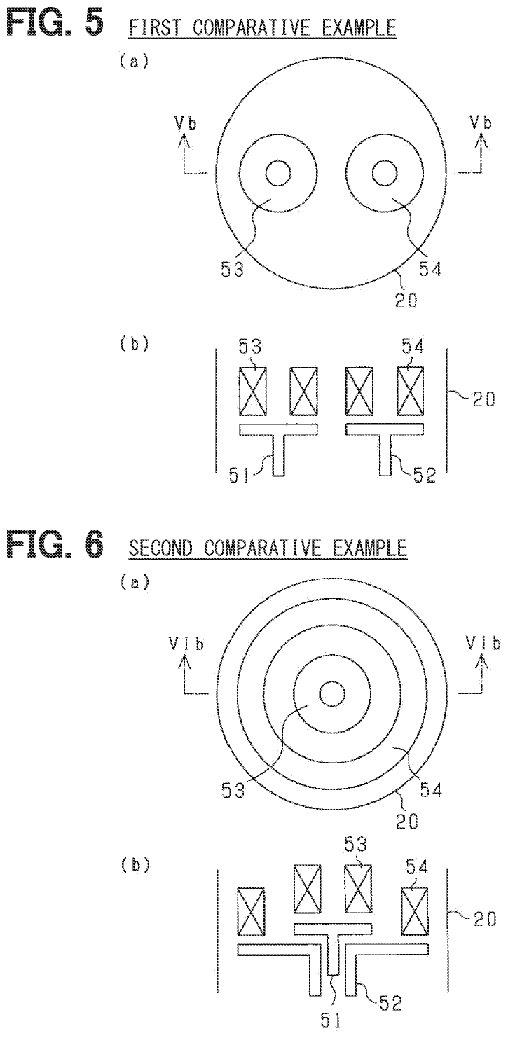

FIG. 5(a) is a plan view showing a positional relationship between the two actuators 53 and 54 of a first comparative example. FIG. 5(b) is a sectional view taken along a line Vb-Vb of FIG. 0.5(a). The first comparative example is an example in which the second control valve 52 and the second actuator 54 are of the same sizes as the first control valve 51 and the first actuator 53 and are arranged side by side in the lateral direction with the first control valve 51 and the first actuator 53. In this first comparative example, the sum of the outer diameters of the two actuators 53, 54 need to be smaller than the inner diameter of the valve body 20.

FIG. 6(a) is a plan view showing a positional relationship between the two actuators 53 and 54 of a second comparative example. FIG. 6(b) is a sectional view taken along a line VIb-VIb of FIG. 6(a). The second comparative example is an example in which the first control valve 51 is disposed inside the second control valve 52, and the first actuator 53 is disposed inside the second actuator 54. In the second comparative example, outward expansion of the first actuator 53 is limited by the second actuator 54, and inward expansion of the second actuator 54 is limited by the first actuator 53.

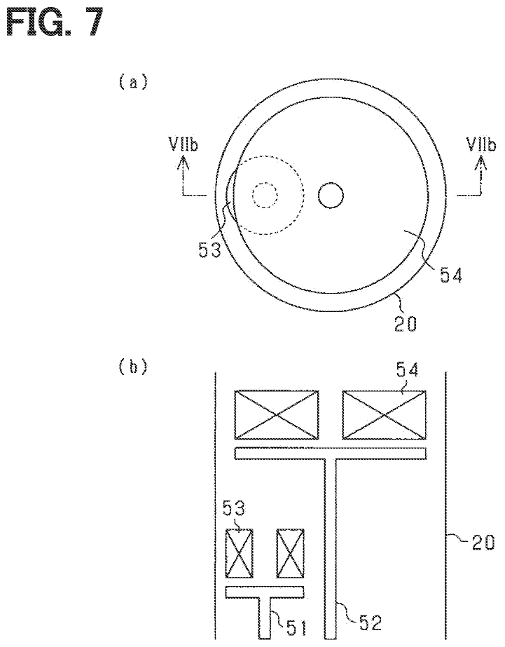

FIG. 7(a) is a plan view showing a positional relationship between the two actuators 53 and 54 of the present embodiment. FIG. 7(b) is a sectional view taken along a line VIIb-VIIb of FIG. 0.7(a). As described above, in a plan view, the center line of the first housing recess 44 and the center line of the second housing recess 48 are eccentric. Therefore, the center lines of the first control valve 51 and the first actuator 53 which are housed in the first housing recess 44 are eccentric from the center lines of the second control valve 52 and the second actuator 54 which are housed in the second housing recess 48.

Since the second control valve 52 is longer than the first control valve 51, the second actuator 54 that drives the second control valve 52 is arranged above the first actuator 53 that drives the first control valve 51 while the lower part of the second control valve 52 is arranged side by side in the lateral direction with the first control valve 51. Accordingly, the first actuator 53 and the second actuator 54 are prevented from interfering with each other, and a part of the second actuator 54 is overlapped with the first actuator 53 in the plan view.

According to the present embodiment, the following effects can be obtained. The upward moving speed and the downward moving speed of needle valve 31 can be controlled because the first outflow passage 25, the second outflow passage 27, the first control valve 51, the second control valve 52, the first actuator 53 and the second actuator 54 are provided, for example.

Further, since the second actuator 54 is partially overlapped with the first actuator 53 in the plan view, an area of the first actuator 53 or an area of the second actuator 54 can be easily increased. Particularly, the area of the second actuator 54 can be easily increased. Therefore, while saving the spaces of the first actuator 53 and the second actuator 54, it is easy to increase a magnetic pole surface area of the first actuator 53 or the second actuator 54 and increase a driving force. Therefore, for example, even if the fuel injection valve has the same size as a fuel injection valve including only one actuator, the fuel injection valve becomes easy to be used for the a high-pressure fuel system.

The second control valve 52 is longer than the needle valve 31, and thus the second control valve 52 extends to the upper part of the injector body 21. Thus, the second actuator 54 that drives the second control valve 52 can be easily arranged above or at the upper part of the injector body 21. It is easier to secure a large installation space for the second actuator 54 at or above the upper part of the injector body 21 than at the lower part thereof. Thus, an area of the second actuator 54 can be easily increased.

Further, the first control valve 51 is shorter than the needle valve 31 and therefore has a small mass. Therefore, the first actuator 53 is relatively small but can be controlled with a sufficiently high response.

Further, the gap between the inner peripheral surface of the valve attachment hole 49 and the second control valve 52 serves as the part of the low pressure passage 58, so that the structure of a valve body 20 can be simplified.

### Other Embodiments

The present embodiment may also be implemented with the following modifications. For example, the first actuator 53 or the second actuator 54 may be an actuator other than a solenoid such as a piezo actuator. Further, for example, the second actuator 54 may be provided at a position other than the upper end portion or above the injector body 21.

Further, for example, instead of forming each of the orifices 14a, 27a, 42a, the diameters of the flow paths 14, 27, 42 themselves including them may be reduced so that the flow paths 14, 27, 42 themselves can function as orifices.

Further, for example, instead of the arrangement in which the longitudinal direction of the second control valve 52 is parallel to the longitudinal direction (up-down direction) of the needle valve 31, the longitudinal direction of the second control valve 52 may be set slightly oblique to the longitudinal direction of the needle valve 31. Further, for example, instead of the configuration in which the second control valve 52 opens and closes the second outflow passage 27, the second control valve 52 may open and close the inflow passage 14.

Further, for example, instead of making the inner diameter of the valve attachment hole 49 larger than the outer diameter of the second control valve 52, a groove extending in the up-down direction may be provided in the valve attachment hole 49 or the second control valve 52, and the groove may secure the low pressure passage 58. Further, for example, instead of forming the gap between the inner peripheral surface of the valve attachment hole 49 and the rod portion 52b as a part of the low pressure passage 58, a hole extending parallel to the valve attachment hole 49 may be provided beside the valve attachment hole 49 as a part of the low pressure passage 58.

Further, for example, the driven valve 41 may be omitted. In that case, when both the first control valve 51 and the second control valve 52 are closed, the pressures in the control chamber 46 and the back pressure chamber 36 becomes high. In this state, when both the first control valve 51 and the second control valve 52 are opened, the pressures relatively quickly become low. When only one is opened, the pressures relatively slowly become low.

Further, for example, in FIG. 7(a), a part of the second actuator 54 overlaps with a part of the first actuator 53 in the plan view. However, a whole part of the first actuator 53 may overlap with a part of the second actuator 54 in the plan view. Further, for example, in FIG. 7(b), the lower portion of the second control valve 52 is arranged side by side in the lateral direction with the entire first control valve 51, but the lower portion of the second control valve 52 may be arranged side by side in the lateral direction only with the upper portion of the first control valve 51.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

1. A fuel injection valve comprising:
a valve body having an injection hole at an end of the valve body facing in a first direction;
a needle valve provided inside the valve body and movable in an axial direction which includes both the first direction and a second direction opposite to the first direction, the needle valve closing the injection hole according to a movement of the needle valve in the first direction, the needle valve opening the injection hole according to a movement of the needle valve in the second direction;
a back pressure chamber provided inside the valve body such that the needle valve faces the back pressure chamber in the second direction, an increase in internal pressure of the back pressure chamber causes the movement of the needle valve in the first direction, and a decrease in internal pressure of the back pressure chamber causes the movement of the needle valve in the second direction;
a first control valve provided inside the valve body and configured to control the internal pressure of the back pressure chamber;
a second control valve provided inside the valve body and configured to control the internal pressure of the back pressure chamber;
a first actuator configured to control the first control valve; and
a second actuator configured to control the second control valve, wherein
the first control valve includes a first rod portion extending in the axial direction, and a first umbrella portion having an umbrella shape and provided at an end of the first rod portion facing in the second direction,
the second control valve includes a second rod portion extending in the axial direction, and a second umbrella portion having an umbrella shape and provided at an end of the second rod portion facing in the second direction,
the second control valve is longer than the first control valve in the axial direction,
a direction orthogonal to the axial direction is defined as a lateral direction,
a part of the second rod portion is arranged side by side in the lateral direction with the first umbrella portion,
the second umbrella portion is located away in the second direction from the first umbrella portion,
a distance in the lateral direction between the second rod portion and an outer peripheral edge of the second umbrella portion is longer than a distance in the lateral direction between the first rod portion and an outer peripheral edge of the first umbrella portion such that the second umbrella portion overlaps with the first rod portion in a plan view along the axial direction,
the second actuator is located away in the second direction from the first actuator, and
a part of the second actuator overlaps at least a part of the first actuator when viewed in the plan view.

2. The fuel injection valve according to claim 1, wherein
the second control valve is inserted into a valve attachment hole provided in the valve body, and
a gap between an inner peripheral surface of the valve attachment hole and the second control valve forms a part of a low pressure passage through which the internal pressure of the back pressure chamber is released.

3. The fuel injection valve according to claim 1, wherein
the first control valve is shorter than the needle valve in the axial direction.
